(19) United States
(12) Patent Application Publication
(10) Pub. No.: US 2006/0115626 A1
(43) Pub. Date: Jun. 1, 2006

(54) Component adapted to receive foam-in-place seal

(75) Inventor: David A. Hill, Royal Oak, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 10/998,720

(22) Filed: Nov. 30, 2004

(51) Int. Cl. B32B 3/30

(52) U.S. Cl. 428/167

(57) ABSTRACT

A molding or trim component adapted to be secured to an automotive part. A plurality of elongated receptacles are defined in or on the rear mounting face of the component and an elongated strip of elastomeric material is disposed to overlie at least a portion of the elongated receptacles. At least a portion of the elastomeric material is disposed in the receptacles to secure the strip of elastomeric material to the component.

### BACKGROUND OF THE INVENTION

Moldings are often provided on automotive vehicles both for aesthetics and to protect the vehicle finish from marring impacts. Some moldings are chrome-plated, either metal trim pieces or plastic parts that are chrome plated.

Because it's surface is so hard, if a chrome trim piece shifts slightly while contacting the painted finish on the vehicle, it will scratch the finish. Additionally, the chrome component can undergo a galvanic reaction with the metal part to which it is mounted if the paint finish is scratched or chipped. Thus, chrome and chrome-plated components are desirably maintained spaced from the adjacent paint finish of the automotive part. Therefore, conventional trim or other decorative and/or functional molding on, e.g. an automotive part, advantageously includes a layer or spacer (compressible in many cases so that the chrome surface of the trim does not contact the painted surface of the automotive part. Thus, the spacer serves as an isolator to isolate the components from one another although they are held in close proximity.

Conventionally, moldings are attached to the vehicle body with mechanical fasteners, by welding or the like. The spacer layer provided to space the trim component from the automotive part is clamped between the trim component and the automotive part when the trim component is attached to the vehicle. Before the trim component is attached to the vehicle, however, it must be packaged and handled. If the spacer material does not adhere sufficiently to the component then it will become dislodged. As a result, when the trim component is fastened to the vehicle, the spacer material may be missing, so as to risk damage to the automotive part over time, or a part of the seal may undesirably be visible when the trim is attached.

Foam-in-place seal material has the advantage that it can be quickly applied to a trim component to define a spacer to space the trim component from the show surface of the vehicle. However, some foam-in-place seals do not adhere well to chrome-plated components, and others are slow to cure. More particularly, while some foam-in-place seals, such as urethane based seals, exhibit a fairly good adherence to chrome substrates, other, rubber based foam-in-place seals do not adhere well. On the other hand, rubber based foam-in-place seals, referred to as a hot melt rubber, are desirable because they process very quickly, whereas urethane based seals do not process very quickly.

Because rubber foam seals do not adhere well to chrome components, the provision of rubber foam-in-place seals has not been pursued and, instead, trim piece manufacturers/suppliers have provided a die cut piece of foam with double sided tape mounted thereto to adhere the foam seal in place on the mounting face of the component.

### BRIEF DESCRIPTION OF THE INVENTION

The invention relates to articles of manufacture that are adapted to be mechanically secured to a supporting structure, in particular articles having a sub-structure of metal or thermoplastic and an external metallic plating on the substructure and wherein an elastomeric material is disposed between the article of manufacture and supporting structure for the purpose of defining a barrier between the components to prevent contact between the components and consequent electro-chemical deterioration of or mechanical damage to the supporting structure.

More specifically, the present invention provides a seal holding structure on a rear, mounting face of a component to facilitate adherence of a seal material to the component, particularly during packaging and handling. In an exemplary, non-limiting example, the component is a trim piece or molding for an automotive vehicle.

Thus, the invention may be embodied in an article of manufacture that is adapted to be secured to a supporting structure, the article of manufacture comprising: an elongated main body having a front show face, a rear mounting face, and first and second longitudinal side edges; at least one receptacle comprising a groove defined in or on said rear mounting face of said main body; and an elongated strip of elastomeric material disposed on said rear mounting face of said main body, to overlie at least a portion of said at least one receptacle, at least a portion of said elastomeric material being disposed in said receptacle thereby to secure said strip of elastomeric material to said main body.

The invention may also be embodied in an elongated molding component that is adapted to be secured to an automotive part, the component comprising: an elongated main body having a front show face, a rear mounting face, and first and second longitudinal side edges; a plurality of elongated receptacles defined in or on said rear mounting face of said main body; and at least one elongated strip of elastomeric material disposed on said rear mounting face of said main body, to overlie at least a portion of said elongated receptacles, at least a portion of said elastomeric material being disposed in said receptacles thereby to secure said strip of elastomeric material to said main body.

The invention may also be embodied in an assembly comprising a trim component having a non-conductive body structure with a metallic surface and a foam-in-place seal material applied to a rear mounting face of said trim component, said foam-in-place seal material disposed longitudinally of the trim component, adjacent to but spaced inwardly from each longitudinal edge of the trim component, and said foam-in-place seal material including locking portions thereof flowed into receptacles comprising grooves defined in or on said rear mounting face of the trim component for securing said foam-in-place seal material to said trim component.

### BRIEF DESCRIPTION OF THE DRAWINGS

FIG. 1 is a schematic perspective view of a motor vehicle having a molding or trim piece mounted thereto;

FIG. 2 is a schematic perspective view of an outer or front, show face of a molding embodying the invention;

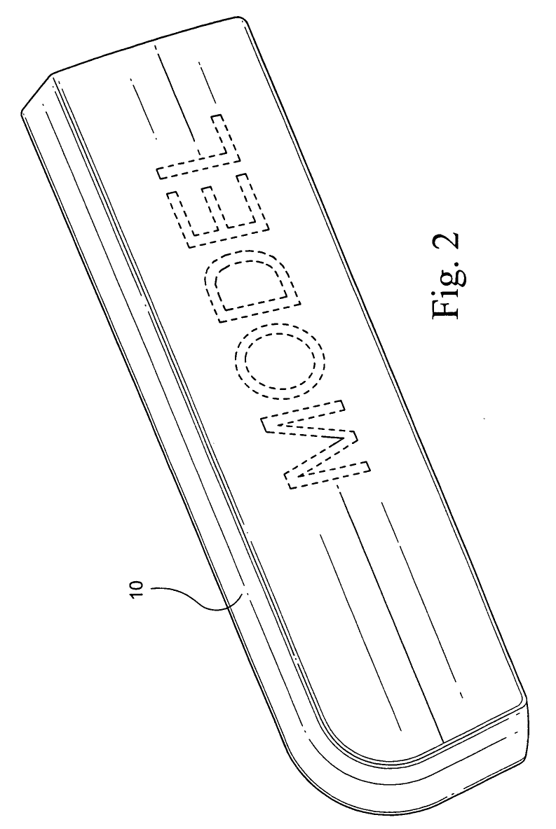

FIG. 3 is a schematic perspective view of an inner or rear, mounting face of the molding FIG. 2;

FIG. 4 is an enlarged schematic cross-sectional view of the molding of FIG. 3;

FIG. 5 is a schematic perspective view of the FIG. 3 component with an elastomeric material in the form of a foam seal applied thereto; and

FIG. 6 is an enlarged schematic cross-sectional view of the molding piece of FIG. 5.

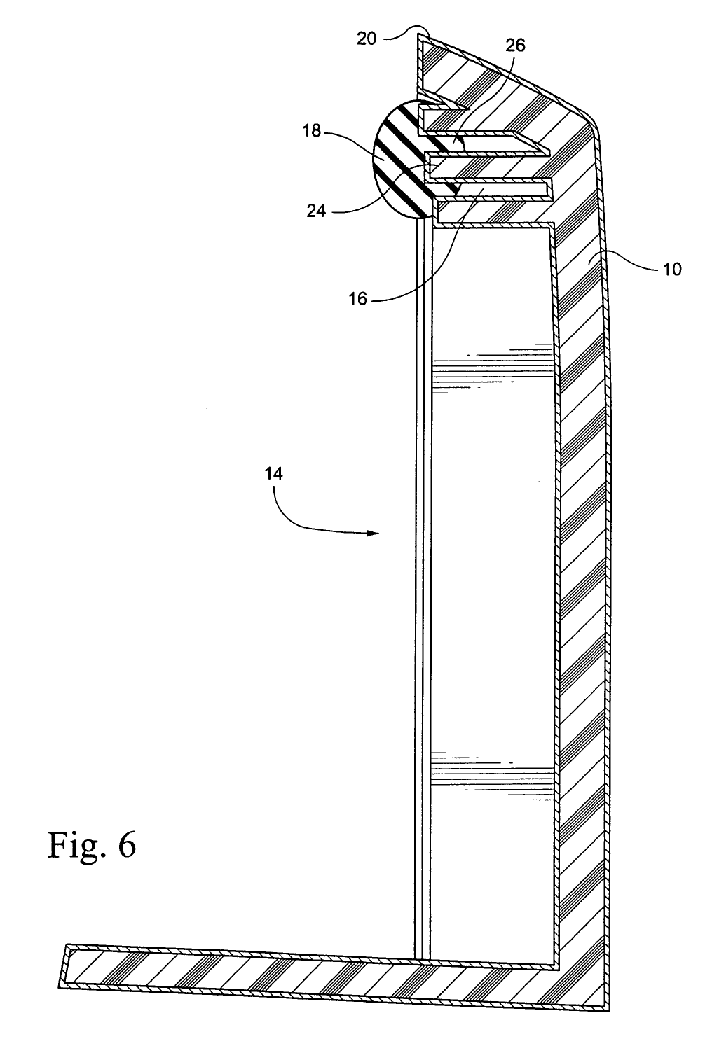

### DETAILED DESCRIPTION OF THE INVENTION

This invention relates to articles of manufacture that are adapted to be mechanically secured to a supporting structure, such as molding and other trim components, particularly for vehicles such as automobiles, sport utility vehicles, pick-up trucks and similar such vehicles having the functional and ornamental detail of trim components mounted to a painted surface thereof. This invention relates more particularly to chrome moldings and trims and a method for providing an elastomeric material to define a barrier between the molding or trim component and the painted surface of the vehicle.

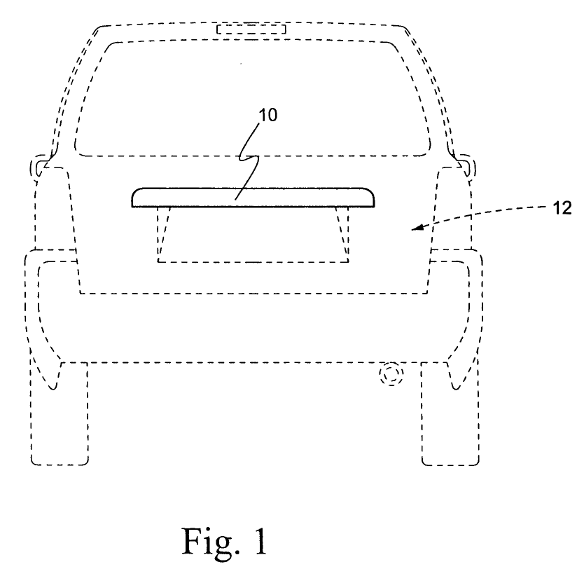

As illustrated in FIG. 1, molding and trim component(s) 10 are conventionally provided, e.g., on the liftgate 12 or other vehicle panels, to mount lights, to provide a decorative detail and/or to shield these automotive parts from damage due to light impacts. Thus, while the molding and trim components provide a function, they also provide a decorative accent. Trim components have been made from a variety of materials. Some such components are made from metal such as chrome-plated steel and are secured in place by fasteners such as metal clips, screws and the like. With the availability of plastic materials that are lightweight and low cost, the use of plastic trim moldings has increased significantly. Plastic moldings can be given the appearance of a metal molding by procedures such as sputtering or electroless plating among other processes to impart a metallic looking appearance.

When metal is used as or on an automotive trim or molding piece, there is the potential for electro chemical corrosive action to be initiated if the molding and the body metals are dissimilar and come into contact. Also, if the chrome-plated trim piece contacts the paint, slight movements of the trim will mar the finish. It is therefore desirable to provide an inert, elastomeric spacer component to slightly space the trim component from the paint on the automotive part.

A foam seal would be a preferred elastomeric material because it can be compressed as appropriate to fill the gap between the part and the trim piece so that the trim piece is held tightly in place without contacting the paint finish. In general, a rubber foam-in-place seal would be a particularly preferred isolator for trim pieces, because its quick cure time would accelerate the manufacturing and assembly process. An exemplary rubber foam seal is sold under the trade name KRATON®.

A problem with foam-in-place seals, however, is that they do not adhere well to chrome-plated components. To address this problem and to facilitate adherence of the elastomeric material to the component, in an embodiment of the invention, the rear mounting face 14 of the component 10 includes at least one elongated receptacle 16 for receiving and holding the elastomeric seal material 18 along the length of the trim piece 10. In this regard, by providing receptacle(s) 16 for the elastomeric material along the length of the component, when the elastomeric seal material is applied, the flowing material will flow into the receptacle(s) and will quickly cure in place, mechanically, e.g. frictionally, holding the elastomeric seal material to the trim component. In the case of “foam-in-place” seal material, the foaming of the seal material causes it to expand and even more assuredly frictionally lock against the walls of the narrow, elongated receptacle(s) 16, thereby coupling the foam seal to the trim component.

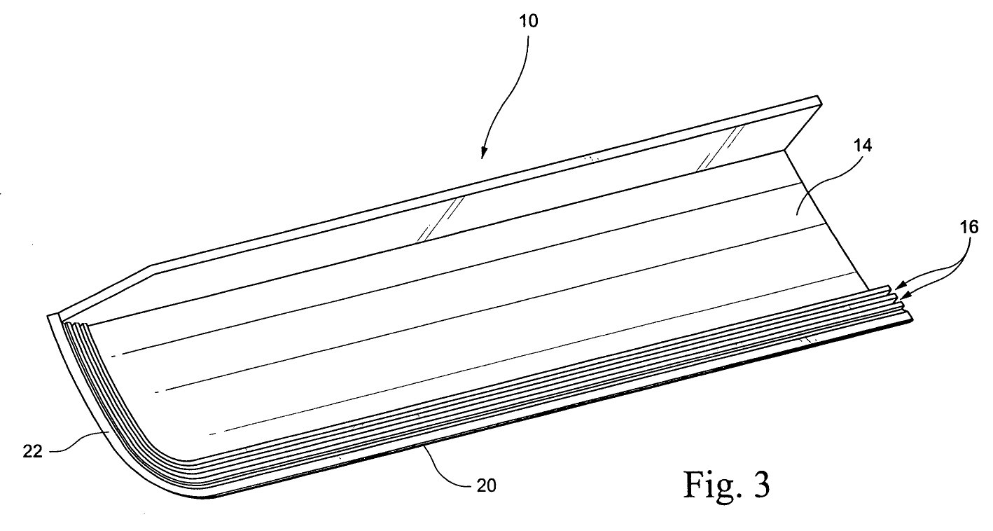

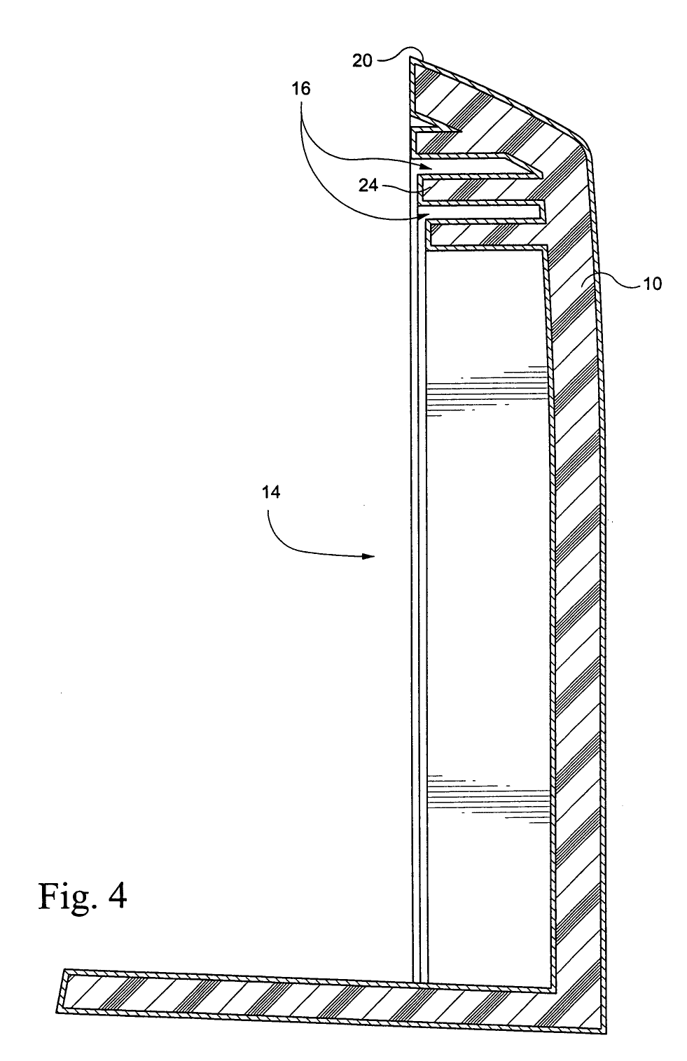

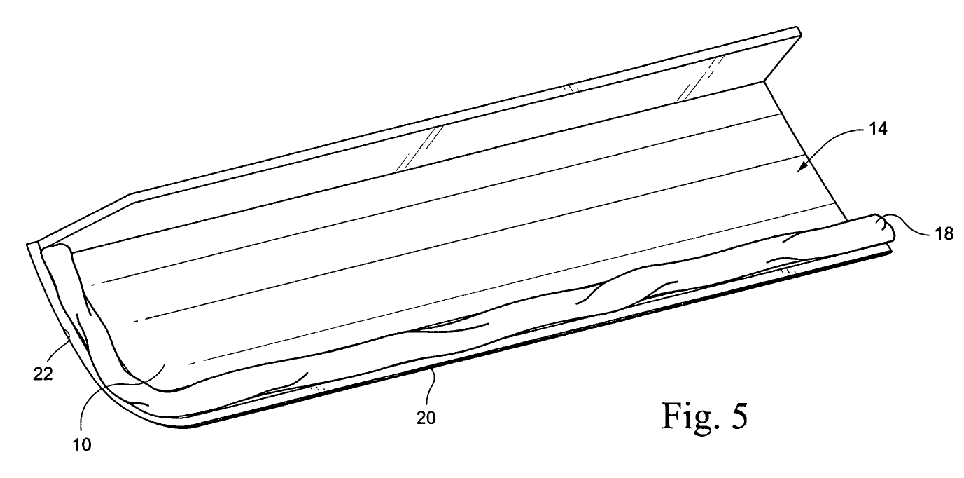

In the an embodiment of the invention, the elongated receptacles for receiving and holding the elastomeric material are oriented in parallel to the longitudinal axis of the component, and extend along at least a portion of the length of the component, adjacent to but spaced from the longitudinal edge 20 and end edge 22 of the component, which will be proximate the painted surface of the vehicle part. In the illustrated embodiment, a bead or strip of elastomeric seal material 18 is defined adjacent and along only one longitudinal edge of the trim piece. It is to be appreciated, however, that some molding and trim components may desirably have a bead or strip of elastomeric material along both longitudinal edges. In any event, the elongated narrow receptacles for receiving locking portion(s) 26 of the seal material are defined where the seal material is to be disposed or is suggested to be disposed. In the illustrated embodiment, therefore, the receptacles are defined adjacent and along the longitudinal edge 20 and end edge 22 of the trim piece 10. More specifically, in the illustrated embodiment, the receptacles are longitudinally extending grooves 16 defined by a plurality of spaced, longitudinally extending ribs 24. Three ribs defining three grooves are provided in the embodiment of FIGS. 3-5. It is to be understood, however, that a single line of longitudinal receptacle(s) may be deemed sufficient to hold the foam-in-place seal during packaging and handling in advance of mounting to the vehicle. Providing two or more lines or rows of longitudinal receptacle(s) will even more assuredly hold the seal in place and will resist lateral forces or rocking movement and the attendant risk of disengagement of the seal.

It is to be understood that although longitudinally extending grooves are provided on the rear, mounting face of the illustrated trim piece, the receptacles for the foam-in-place seal may be discontinuously defined along the length of the trim piece. Moreover, rather than longitudinally extending receptacles, transversely extending receptacles or cross-shaped receptacles may be considered as yet further alternatives, provided the receptacles are sufficiently large for in-flow of the seal material thereinto and yet sufficiently narrow to ensure that the holding function is achieved.

The height of the seal material is determined so as to be great enough to maintain the parts in spaced relation while keeping the seal material from spilling out onto the show surface of the vehicle when the trim piece is mounted to the vehicle. In an exemplary embodiment, the nominal height of the foam-in-place seal ranges from 2.0 to 3.2 mm. It is desirable to maintain the edge of the foam melt 1.5-2.0 mm from the edge of the part. That is, preferably no closer than 1.5 mm to prevent expulsion of the seal and, on the other hand, preferably no farther than 2 mm to provide a consistent look or finish at the trim/automotive part interface. Of course the height of the seal depends on the component and the part to which it is attached.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An article of manufacture that is adapted to be secured to a supporting structure, the article of manufacture comprising:
an elongated main body having a front show face, a rear mounting face, and first and second longitudinal side edges;
at least one receptacle comprising a groove defined in or on said rear mounting face of said main body; and
an elongated strip of elastomeric material disposed on said rear mounting face of said main body, to overlie at least a portion of said at least one receptacle, at least a portion of said elastomeric material being disposed in said receptacle thereby to secure said strip of elastomeric material to said main body.

2. The article of manufacture as in claim 1, wherein said main body comprises a core and a metal coating layer disposed thereon.

3. The article of manufacture as in claim 2, wherein said metal coating layer is chrome.

4. The article of manufacture as in claim 1, wherein said groove of said at least one receptacle extends in parallel with a longitudinal axis of said main body, and said elastomeric material extends into said groove.

5. The article of manufacture as in claim 1, wherein there is at least one receptacle defined adjacent to at least one longitudinal edge of said main body.

6. The article of manufacture as in claim 5, wherein said grooves of said receptacles extend in parallel with a longitudinal axis of said main body, and said elastomeric material extends into said grooves.

7. The article of manufacture as in claim 1, wherein said elastomeric material comprises a foam-in-place seal.

8. The article of manufacture as in claim 1, wherein an elongated rib is disposed in parallel to and adjacent said longitudinal side edge of said main body so as to define a said receptacle adjacent to each longitudinal edge of said main body.

9. The article of manufacture as in claim 1, wherein at least a pair of elongated ribs are disposed in parallel to and adjacent a said longitudinal side edge of said main body so as to define a said receptacle therebetween, adjacent to said longitudinal edge of said main body.

10. An elongated molding or trim component that is adapted to be secured to an automotive part, the component comprising:
an elongated main body having a front show face, a rear mounting face, and first and second longitudinal side edges;
a plurality of elongated receptacles defined in or on said rear mounting face of said main body; and
at least one elongated strip of elastomeric material disposed on said rear mounting face of said main body, to overlie at least a portion of said elongated receptacles, at least a portion of said elastomeric material being disposed in said receptacles thereby to secure said strip of elastomeric material to said main body.

11. The component as in claim 10, wherein said main body comprises a core and a metal coating layer disposed thereon.

12. The component as in claim 11, wherein said metal coating layer is chrome.

13. The component as in claim 10, wherein at least one said receptacle extends in parallel to a longitudinal axis of said main body.

14. The component as in claim 10, wherein there is at least one receptacle defined adjacent to a said longitudinal edge of said main body.

15. The component as in claim 10, wherein said elastomeric material comprises a foam-in-place seal.

16. The component as in claim 10, wherein an elongated rib is disposed in parallel to and adjacent a said longitudinal side edge of said main body, and a said receptacle is defined by the gap between said rib and the respective longitudinal edge of said main body.

17. The component as in claim 10, wherein at least a pair of elongated ribs are disposed in parallel to and adjacent a said longitudinal side edge of said main body so that said pair of ribs defines a said receptacle therebetween, adjacent to said longitudinal edge of said main body.

18. The component as in claim 10, secured to an automotive part.

19. An assembly comprising a molding or trim component having a non-conductive body structure with a metallic surface and a foam-in-place seal material applied to a rear mounting face of said trim component, said foam-in-place seal material disposed longitudinally of the trim component, adjacent to but spaced inwardly from a longitudinal edge of the trim component, and said foam-in-place seal material including locking portions thereof flowed into receptacles comprising grooves defined in or on said rear mounting face of the trim component for securing said foam-in-place seal material to said trim component.
